(19) United States
(12) Patent Application Publication
(10) Pub. No.: US 2024/0116215 A1
(43) Pub. Date: Apr. 11, 2024

(54) CONCRETE CUTTING SAW BLADE

(71) Applicant: Tianjin Kenboli Precision Tools Co., Ltd., Tianjin City (CN)

(72) Inventor: Cheng Yang, Huaihua City (CN)

(21) Appl. No.: 17/976,258

(22) Filed: Oct. 28, 2022

(30) Foreign Application Priority Data
Oct. 11, 2022 (CN) 202222704843.2

(51) Int. Cl. B28D 1/12

(52) U.S. Cl. CPC B28D 1/121

(57) ABSTRACT

The present application provides a concrete cutting saw blade, which relates to the technical field of diamond tools. The concrete cutting saw blade comprises a base body and a cutter head, wherein the base body and the cutter head are connected by welding, the cutter head comprises a body part, a wear-resistant layer and a filler, the body part is made of the same material as the base body, the wear-resistant layer is provided on one side of the body part on the blade surface of the cutter head, the body part is provided with a narrow slit at the edge of the blade, and the filler is provided in the narrow slit. The technical scheme solves the technical problems in the prior art that the concrete cutting saw blade is complicated to manufacture, high in cost and unstable in quality.

### TECHNICAL FIELD

The present application relates to the technical field of diamond tools, in particular to a concrete cutting saw blade.

### BACKGROUND

The cutter head of a traditional concrete cutting saw blade uses powder metallurgy. All kinds of metal powders and diamonds are uniformly mixed by a mixer, and the mixed powders are granulated by a pelletizer. Then, the granulated powder is put into a mold and pressed into the shape of a cutter head by a cold press. Finally, the pressed blank is put into a hot press mold, and is put into a sintering machine as a whole, and finally the cutter head is sintered and molded. After the sintered cutter head grinds the welding surface, the pressed blank is welded on the base body of the disc-shaped saw blade by laser welding or high-frequency welding.

The traditional concrete cutting saw blade is complicated to manufacture, high in cost and unstable in quality. Moreover, even if laser welding with better strength is used, due to the formula of a cutter head and other reasons, quality problems such as welding blistering will inevitably occur, which will affect the welding strength between the cutter head and the base body. Therefore, the saw blade often loses its cutter head during use.

Moreover, because the cutter head of the traditional concrete saw blade is made by powder metallurgy, the metal powder can only keep a simple mechanical coating on the diamond. Under complicated and harsh cutting conditions, the diamond in the cutter head of the saw blade is easy to fall off, resulting in the excessive life loss or even failure of the saw blade.

In addition, in the last two years, a concrete cutting saw blade produced using an integrated brazing method has appeared on the market. Because of its integrated design, the cost of designing and manufacturing the base body of the saw blade has increased greatly, and the final brazing manufacturing cost has also doubled due to the huge overall size of the product. Moreover, due to the integrated design of the product, the design of the cutter head of the product is single, which cannot cope with the ever-changing cutting conditions in practice.

### SUMMARY

The object of the present utility model is to provide a concrete cutting saw blade to solve the technical problems in the prior art that the concrete cutting saw blade is complicated to manufacture, high in cost and unstable in quality. Many technical effects produced by the preferred technical scheme among the technical schemes provided by the present utility model are detailed in the following description.

In order to achieve the above object, the present utility model provides a concrete cutting saw blade, comprising a base body and a cutter head, wherein the base body and the cutter head are connected by welding, the cutter head comprises a body part, a wear-resistant layer and a filler, the body part is made of the same material as the base body, the wear-resistant layer is provided on one side of the body part on the blade surface of the cutter head, the body part is provided with a narrow slit at the edge of the blade, and the filler is provided in the narrow slit.

Preferably, both the base body and the body part of the cutter head are made of carbon steel, and the base body and the body part of the cutter head are connected by laser welding or high-frequency welding.

Preferably, there are a plurality of cutter heads which are equidistantly provided on the circumference of the base body, and a chip discharge groove is provided on the circumference of the base body between every two cutter heads.

Preferably, the narrow slits are a plurality of inverted trapezoidal narrow slits with midlines parallel to each other.

Preferably, the filler is formed by filling the mixed filler of a diamond and a bonding agent into the narrow slit by brazing.

Preferably, a wear-resistant layer is provided on the side of the body part opposite to the blade surface.

Preferably, the wear-resistant layer is connected to the body part by welding.

Preferably, the wear-resistant layer is connected with the body part by brazing after being uniformly arranged on the body part by the mixture of the diamond and the bonding agent.

Preferably, the base body is disc-shaped, and the center of the base body is provided with a shaft hole.

The technical scheme of the present utility model can include the following beneficial effects.

The present utility model provides a concrete cutting saw blade. The cutting saw blade of the present utility has the advantages that the cutter head of the traditional cutting blade is separated from the base body. A plurality of cutter heads with different structures and formula designs are welded on the same base body. Since the welding surface of the cutter head and the welding surface of the base body can be made of the same carbon steel material when the cutter head is welded on the base body after being made, it is very easy to weld together by laser welding. The welding strength is very high, the overall life is the same as that of the integrated design, it is simple to manufacture, and the cost is low. Compared with the traditional saw blade, the concrete cutting saw blade can completely avoid the situation that the cutter head falls off. On the other hand, according to the present utility model, the wear-resistant layer is provided on the outer side of the body part of the cutter head, and the strength of the cutter head increases exponentially, thus ensuring that the internal material of the cutter head can be fully utilized without falling off in the cutting process, and greatly prolonging the service life of the saw blade. Therefore, the technical scheme solves the technical problems in the prior art that the concrete cutting saw blade is complicated to manufacture, high in cost and unstable in quality.

### BRIEF DESCRIPTION OF THE DRAWINGS

In order to explain the embodiments of the present utility model or the technical schemes in the prior art more clearly, the drawings that need to be used in the description of the embodiments or the prior art will be briefly introduced hereinafter. Obviously, the drawings in the following description are only some embodiments of the present utility model. For those skilled in the art, other drawings can be obtained according to these drawings without any creative effort.

FIG. 1 is a structural schematic diagram of a concrete cutting saw blade according to an embodiment of the present utility model.

FIG. 2 is a structural schematic diagram of a cutter head of a concrete cutting saw blade according to an embodiment of the present utility model.

FIG. 3 is another structural schematic diagram of a cutter head of a concrete cutting saw blade according to an embodiment of the present utility model.

FIG. 4 is a structural schematic diagram of a blade of a concrete cutting saw blade according to an embodiment of the present utility model.

In the figures: 1. Base body; 11. Shaft hole; 12. Chip discharge groove; 13. Welding surface of a base body; 2. Cutter head; 21. Welding surface of a cutter head; 22. Narrow slit; 23. Wear-resistant layer; 24. Filler; 25. Body part.

### DETAILED DESCRIPTION OF THE EMBODIMENTS

In order to make the object, technical scheme and advantages of the present utility model clearer, the technical scheme of the present utility model will be described in detail hereinafter. Obviously, the described embodiments are only part of the embodiments of the present utility model, rather than all of the embodiments. Based on the embodiment of the present utility model, all other embodiments obtained by those skilled in the art without any creative effort belong to the scope of protection of the present utility model.

In the description of the present utility model, it should be noted that the orientational or positional relationships indicated by the terms such as “center”, “up”, “down”, “left”, “right”, “vertical”, “horizontal”, “inside” and “outside” are based on the orientational or positional relationships shown in the drawings only for the convenience of describing the present utility model and simplifying the description, rather than indicate or imply that the referred devices or elements must have a specific orientation, be constructed and operated in a specific orientation, and therefore should not be construed as limiting the present utility model. In addition, the terms such as “first”, “second” and “third” are only used for the purpose of description, and cannot be understood as indicating or implying relative importance.

In the description of the present utility model, it should also be noted that unless otherwise specified and defined expressly, the terms such as “mount”, “link” and “connect” should be understood broadly, for example, it can be fixed connection, detachable connection or integral connection; or mechanical connection or electrical connection; or direct connection or indirect connection through an intermediate medium, or internal communication of two elements. For those skilled in the art, the specific meanings of the above terms in the present utility model can be understood according to specific situations.

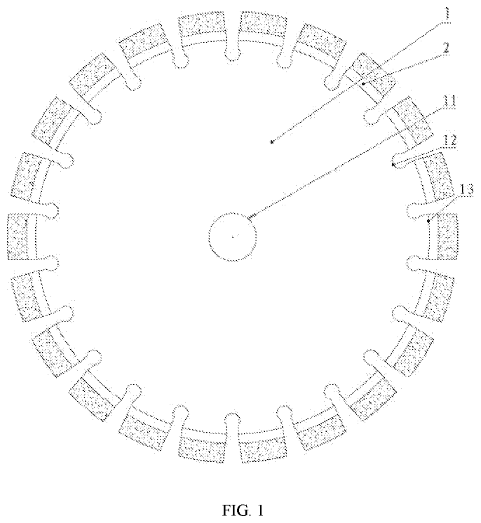

FIG. 1 is a structural schematic diagram of a concrete cutting saw blade according to an embodiment of the present utility model, as shown in FIG. 1.

The present utility model provides a concrete cutting saw blade, which comprises a base body 1 and a cutter head 2, wherein the base body 1 and the cutter head 2 are connected by welding. The cutter head 2 comprises a body part 25, a wear-resistant layer 23 and a filler 24. The body part 25 is made of the same material as the base body 1. The wear-resistant layer 23 is provided on one side of the body part 25 on the blade surface of the cutter head. The body part 25 is provided with a narrow slit 22 at the edge of the blade, and the filler 24 is provided in the narrow slit 22.

Specifically, the cutter head 2 is connected with the base body 1 by welding, so that several cutter heads 2 with different structures and formula designs are welded on the same base body 1. Since the welding surface of the cutter head and the welding surface of the base body can be made of the same carbon steel material when the cutter head 2 is welded on the base body after being made, it is very easy to weld together by laser welding. The welding strength is very high, the overall life is the same as that of the integrated design, it is simple to manufacture, and the cost is low. Compared with the traditional saw blade, the concrete cutting saw blade can completely avoid the situation that the cutter head falls off. On the other hand, according to the present utility model, the wear-resistant layer 23 is provided on the outer side of the body part 25 of the cutter head. The filler 24 is formed in the form of a narrow slit 22 at the blade, so that the body part 25 and the filler 24 are staggered and orderly arranged under the cover of the wear-resistant layer 23. The strength of the cutter head increases exponentially, thus ensuring that the internal material of the cutter head can be fully utilized without falling off in the cutting process, and greatly prolonging the service life of the saw blade.

As an alternative embodiment, the base body 1 and the body part 25 of the cutter head 2 are made of carbon steel, and the base body 1 and the body part 25 of the cutter head 2 are connected by laser welding or high-frequency welding.

Specifically, because the base body 1 is made of carbon steel. The welding surface of the cutter head is also made of carbon steel. The welding surfaces of the base body and the cutter head are made of the same material, so that it is easier to weld the base body and the cutter head than the cutter head of the traditional concrete cutting blade, and the welding strength is higher, which is equivalent to the strength of the integrated saw blade.

Preferably, there are a plurality of cutter heads 2 which are equidistantly provided on the circumference of the base body 1, and a chip discharge groove 12 is provided on the circumference of the base body 1 between every two cutter heads.

Specifically, the chip discharge grooves 12 are provided between the cutter heads 2, and the number of the chip discharge grooves 12 corresponds to the number of the cutter heads 2 one by one, so that the chips generated in the cutting process can be discharged in time through the chip discharge groove 12.

As an alternative embodiment, the narrow slits 21 are a plurality of inverted trapezoidal narrow slits with midlines parallel to each other.

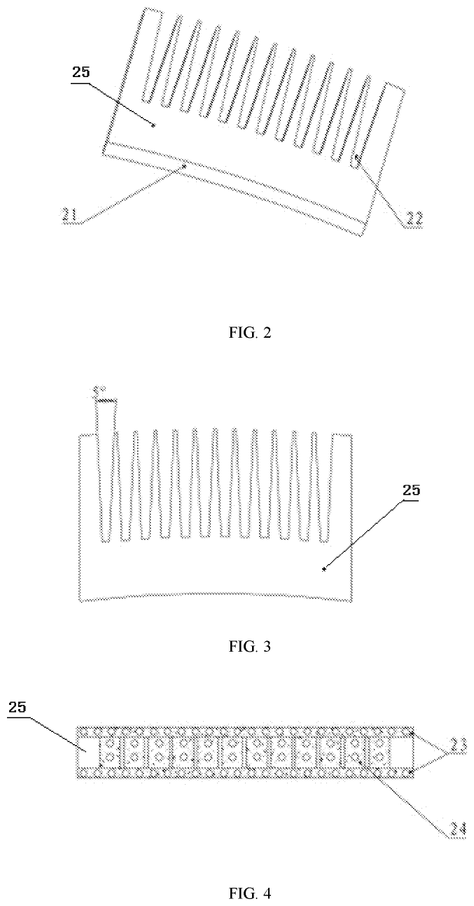

Specifically, as shown in FIG. 2 and FIG. 3, the inverted trapezoidal design of the narrow slit 21 makes it more convenient to manufacture the product, and at the same time, the grinding performance of the diamond can be more prominently exerted during cutting.

As an alternative embodiment, the filler 24 is formed by filling the mixed filler of a diamond and a bonding agent into the narrow slit by brazing. The filler 24 is formed by the mixed filler of the diamond and the bonding agent, and a cover layer is formed by the wear-resistant layer 23, which can effectively prevent the diamond from falling off prematurely due to the immature sintering technology of a traditional sintering cutter head.

As an alternative embodiment, a wear-resistant layer 23 is provided on the side surface of the body part 25 opposite to the blade surface.

Specifically, the wear-resistant layer 23 completely wraps the body part 25 of the cutter head 2 and the filler 24 in the narrow slit, which can improve the protection performance of the cutter head 2.

As an alternative embodiment, the wear-resistant layer 23 is connected to the body part by welding. The combination of the wear-resistant layer 23 and the filler 24 with the body part 25 is more stable by brazing.

As an alternative embodiment, the wear-resistant layer 23 is connected with the body part 25 by brazing after being uniformly arranged on the body part 25 by the mixture of the diamond and the bonding agent.

Specifically, the filler 24 is formed by a mixture of a diamond and a bonding agent into the narrow slit 22 of the body part 25, and the wear-resistant layer 23 provided on the side of the cutter head 2 is brazed to the body part 25 after being uniformly arranged by the diamond and the bonding agent. Therefore, the filler 24 and the wear-resistant layer 23 can effectively prevent the diamond from falling off prematurely due to the immature sintering technology of a traditional sintering cutter head.

As an alternative embodiment, the base body 1 is disc-shaped, and the center of the base body 1 is provided with a shaft hole 11. The cutting tool can be fixed on the rotating device through the shaft hole 11 of the base body 1.

According to the concrete cutting saw blade shown above, there are the following specific embodiments.

### Embodiment 1

As shown in FIGS. 1-3, in one embodiment of the present utility model, a concrete cutting saw blade with an outer diameter ranging from 350 mm to 950 mm comprises a disc-shaped base body 1 and a plurality of cutter heads 2. There may be 24 to 91 cutter heads per saw blade. The base body and the cutter head are connected by laser welding. The center of the disc-shaped base body 1 is provided with a shaft hole 11. The periphery of the disc-shaped base body 1 is provided with a plurality of chip discharge grooves 12. The number of the chip discharge grooves corresponds to the number of cutter heads one by one. The arc surface between two adjacent chip discharge grooves 12 is the base body welding surface 13. The welding surface 21 of the cutter head 2 is aligned with the welding surface 13 of the base body 1, and then they are welded together by a laser welder after being tightly attached to each other. The outer edge of the cutter head 2 is provided with a plurality of inverted trapezoidal narrow slits 22 parallel to each other. The width of the narrow slits ranges from 0.5 mm to 1.5 mm, and the depth of the narrow slits ranges from 5 mm to 20 mm. The blade surface of the cutter head 2 is welded with a wear-resistant layer 23. The thickness of the wear-resistant layer ranges from 0.3 mm to 1.2 mm. The side of the cutter head 2 is welded with the wear-resistant layer 23. A mixed filler 24 of the diamond and the bonding agent is provided in the slit of the narrow slit 22.

In this embodiment, the cutting saw blade can be fixed on a rotating device through the shaft hole 11 of the base body 1. The periphery of the disc-shaped base body 1 is provided with a plurality of chip discharge grooves 12, through which chips generated in the cutting process can be discharged in time. After the welding surface 13 of the base body between the two chip discharge grooves 12 is tightly attached to the welding surface 21 of the cutter head 2, the base body 1 and the cutter head 2 are integrally connected by laser welding. Because the material of the welding surface of the cutter head is the same as that of the base body, the problem of untight welding caused by blistering of the welding surface in the welding process of the traditional sintering cutter head is avoided. Therefore, the welding strength of the cutter head and the base body is guaranteed to the greatest extent, the overall strength of the cutting saw blade is ensured, and the phenomenon that the cutter head falls off due to the weak welding between the cutter head 2 and the circular base body 1 is eliminated. At the same time, each cutter head 2 is provided with a plurality of narrow slits 22, a mixture of the diamond and the bonding agent is filled the narrow slits 22, and the side of the cutter head 2 is provided with a wear-resistant layer 23. The mixed filler 24 of the diamond and the bonding agent and the wear-resistant layer 23 can effectively prevent the diamond from falling off prematurely due to the immature sintering technology of a traditional sintering cutter head.

### Embodiment 2

This embodiment is another embodiment based on the previous embodiment. In another embodiment, as shown in FIG. 4, in order to maximize the performance of the wear-resistant layer 23 and the mixed filler 24, the wear-resistant layer 23 is formed by being brazed on the side of the cutter head 2 after being uniformly arranged by the mixed filler 24 of the diamond and the bonding agent. The wear-resistant layer 23 completely wraps the cutter head 2, and the mixed filler 24 consists of the diamond and the bonding agent. The mixed filler 24 is brazed in the narrow slit 22, so that the combination of the wear-resistant layer 23 and the mixed filler 24 with the cutter head 2 is more stable by brazing. The wear-resistant layer 23 completely wraps the cutter head, which can improve the protection performance of the cutter head 2. The mixed filler 24 is added into the narrow slit 22, which can prolong the service life of the cutter head 2. The inverted trapezoidal design of the narrow slit makes it more convenient to manufacture the product. At the same time, the grinding performance of the diamond can be more prominently exerted in the cutting process. In addition, the diamond and the bonding agent are used as the materials of the wear-resistant layer 23 and the mixed filler 24, which can maximize the strength of the wear-resistant layer 23 and further protect the overall wear resistance of the cutter head 2.

To sum up, the present utility model has the following beneficial effects.

1. The cutter head of the traditional concrete cutting saw blade is made by powder metallurgy. The cutter head actually belongs to a powder dense body, which is made of a material different from the base body made of carbon steel. The weld seam cannot achieve excellent strength using laser welding or high-frequency welding between the cutter head and the base body. As the cutter head involved in the present utility model uses a carbon steel sheet as the skeleton material, the joint surface between the cutter head and the base body of the saw blade is made of carbon steel when the cutter head is welded with the base body of the saw blade, and is welded using the same material. The welding seam can reach the same strength of the integrated saw blade. However, the laser welding can maximize the strength of the welding seam, and avoid the problem that the cutter head of the traditional concrete cutting saw blade falls off due to weak welding, which eventually leads to the sharp reduction of the service life of the saw blade or even abnormal invalidation.

2. The saw blade head of the traditional concrete saw blade is made by powder metallurgy. The diamonds are arranged in disorder in the cutter head, so that the performance in the cutting process is unstable and the cutting sharpness is low. Since the present utility model welds the diamonds in a fixed narrow slit in an orderly and regular manner, the product has stable performance and high sharpness in the cutting process.

3. The cutter head of the traditional concrete saw blade is made by mixing, pressing and sintering metal powder and a diamond, so that the density of the cutter head itself is poor. The diamond and the metal powder are only mechanically wrapped, so that the bonding strength is low. The present utility model has a longer service life because the cutter head is welded with the diamond through a steel sheet, the cutter head is metallurgically bonded with the diamond, and the bonding strength is improved qualitatively.

4. The cutter head of the traditional concrete saw blade is made of various raw and auxiliary materials by a series of complicated production processes such as mixing materials, granulating, pressing and sintering, etc., during which a lot of complicated and expensive professional devices are needed, so that the cost is high. However, the cutter head in the present utility model can be completed by only one brazing device, and the process is simple, so that the cost is lower.

5. For some concrete cutting saw blades at present, the integrated design of the cutter head and the base body is used, so that the difficulty of making products is higher and the output is lower. In the present utility model, the manufacturing difficulty of the product is reduced by separately welding the cutter head and the base body, and comprehensively, the manufacturing difficulty and the manufacturing cost of a unit saw blade are also reduced to some extent.

The above only describes the specific embodiments of the present utility model, but the scope of protection of the present utility model is not limited thereto. Any changes or substitutions conceivable to those skilled in the art within the technical scope disclosed by the present utility model should be covered within the scope of protection of the present utility model. Therefore, the scope of protection of the present utility model should be based on the scope of protection of the claims.

What is claimed is:

1. A concrete cutting saw blade, comprising a base body and a cutter head, wherein the base body and the cutter head are connected by welding, the cutter head comprises a body part, a wear-resistant layer and a filler, the body part is made of the same material as the base body, the wear-resistant layer is provided on one side of the body part on the blade surface of the cutter head, the body part is provided with a narrow slit at the edge of the blade, and the filler is provided in the narrow slit.

2. The concrete cutting saw blade according to claim 1, wherein both the base body and the body part of the cutter head are made of carbon steel, and the base body and the body part of the cutter head are connected by laser welding or high-frequency welding.

3. The concrete cutting saw blade according to claim 2, wherein there are a plurality of cutter heads which are equidistantly provided on the circumference of the base body, and a chip discharge groove is provided on the circumference of the base body between every two cutter heads.

4. The concrete cutting saw blade according to claim 1, wherein the narrow slits are a plurality of inverted trapezoidal narrow slits with midlines parallel to each other.

5. The concrete cutting saw blade according to claim 4, wherein the filler is formed by filling the mixed filler of a diamond and a bonding agent into the narrow slit by brazing.

6. The concrete cutting saw blade according to claim 1, wherein a wear-resistant layer is provided on the side of the body part opposite to the blade surface.

7. The concrete cutting saw blade according to claim 1, wherein the wear-resistant layer is connected to the body part by welding.

8. The concrete cutting saw blade according to claim 7, wherein the wear-resistant layer is connected with the body part by brazing after being uniformly arranged on the body part by the mixture of the diamond and the bonding agent.

9. The concrete cutting saw blade according to claim 1, wherein the base body is disc-shaped, and the center of the base body is provided with a shaft hole.
